(19) United States
(12) Patent Application Publication
(10) Pub. No.: US 2007/0070016 A1
(43) Pub. Date: Mar. 29, 2007

(54) Pixel sample circuit for active matrix display

(76) Inventor: Sung-Kon Kim, Hsinchu (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 11/319,345

(22) Filed: Dec. 27, 2005

(30) Foreign Application Priority Data
Sep. 23, 2005 (TW) 94133039

(51) Int. Cl. G09G 3/36

(52) U.S. Cl. 345/98

(57) ABSTRACT

A pixel sample circuit for active matrix display is provided. The pixel sample circuit transmits scan line data to the display panel in line pairs, and drives the display panel in column inversion to display the frame. Therefore, the pixel sample circuit of the present invention is able to increase the resolution of the frames displayed without using additional memory and complex algorithm.

### CROSS-REFERENCE TO RELATED APPLICATION

This application claims the priority benefit of Taiwan application serial no. 94133039, filed on Sep. 23, 2005. All disclosure of the Taiwan application is incorporated herein by reference.

### BACKGROUND OF THE INVENTION

1. Field of Invention

The present invention relates to a pixel sample circuit. More particularly, the present invention relates to a pixel sample circuit for an active matrix display.

2. Description of Related Art

Television signals are mostly displayed using the interlacing method, which is the forming of an odd field and an even field for each frame of a TV signal in which the scan lines of one field interlace with the scan lines of another field.

FIG. 1 is a diagram of the TV signal for an interlaced display. Referring to FIG. 1, in which the NTSC television system is used as an example, a frame has 525 scan lines, but has only 484 effective scan lines which actually do contain video data after the deduction of the scan lines used for flyback, and are denoted as 1, 2, 3, . . . 482, 483, and 484, respectively. Furthermore, a frame is composed of an odd field and an even field, in which the odd field includes scan lines denoted as 1, 3, 5, . . . 481, and 483 for the frame, and the even field includes scan lines denoted as 2, 4, 6, . . . 482, and 484 for the frame.

FIG. 2 is a diagram illustrating the operation of an interlaced display TV signal using an LCD. In actuality, the typical driving method of LCD panels is to enable each scan line of the LCD panel sequentially and to input the corresponding data via the data line of the LCD panel when a particular scan line is enabled. The data may be the data contained in a particular effective scan line of the odd field or the even field.

Referring to FIG. 2, in which X and Y represent the data line and the scan line of the LCD panel, respectively. T represents the scan line data of the television signal. When the frames having 484 scan line data (i.e. the odd field and the even field thereof having 242 scan line data, respectively) are displayed using an LCD panel having 240 scan lines, the odd field and the even field of each frame are display alternately. For example, an odd field of the first frame is display on the LCD panel, and then an even field of the first frame is displayed. After that, the odd field of the second frame is displayed, followed by the even field of the second frame. As a result, the odd fields and the even fields of all the frames are displayed alternately.

Under conventional technology, generally the number of scan lines of an LCD panel is increased for increasing the corresponding resolution. For example, the number of scan lines of the LCD panel having 240 scan lines is increased to 480 scan lines. The most commonly used method is to increase the number of scan lines in line pairs. For example, the reference numerals of the transmitted odd field data lines that are originally transmitted are { 1, 3, 5, 7, 9, 11, . . . } sequentially. After line pair processing, they are adjusted to become { 1, 1, 3, 3, 5, 5, 7, 7, 9, 9, 11, 11, . . . }. Thus, it means that the data of each data line is transmitted twice. Similarly, the scan lines of the even fields are increased in line pairs thus the resolution of the LCD panel is improved.

Referring to FIG. 3, it is a circuit diagram of a conventional pixel sample circuit in an LCD panel, and will be described using the transmission method of the scan line data of the odd field. In the aforementioned circuit, the scan line data of the odd field are transmitted sequentially and continuously via the on/off of the control switches 301 to 307. For example, when the data line is about to transmit the first scan line data, the switch 301 is turned on to store the first scan line data into the capacitor C1. Then the switch 303 is turned on to transmit the first scan line data stored in the capacitor C1. However, the switch 307 is presently in open circuit status, so that the second scan line data cannot be transmitted. On the contrary, when the next scan line data is to be transmitted, the same method described above is used for controlling the operation of the switches 305 and 307.

As described above, if the method using line pair is used for improving the resolution of the LCD panel, additional memory has to be further added in the pixel sample circuit for storing the additional scan line data. Moreover, if the same bias is applied to the same data line during the process of displaying the odd fields and even fields alternately and continuously, an electric field of a single direction is thus applied constantly to the liquid crystal. As a result, the twisting characteristics of liquid crystal will be negatively affected or to the point of complete failure. At the same time, the frames displayed by the LCD panel shall be flickering as well.

### SUMMARY OF THE INVENTION

Accordingly, the present invention is directed to provide a pixel sample circuit for active matrix display which allows driving the LCD panel in column inversion and improves the resolution of frames without the needs of extra memory or complex algorithm.

The present invention provides a pixel sample circuit for active matrix display, which is used for providing the pixel signals required by a data line, and the pixel sample circuit includes a first pixel sample unit and a second pixel sample unit. Wherein, the first pixel sample unit receives an N^{th} pixel signal having a first polarity and an N^{th} pixel signal having the second polarity, and outputs one of the N^{th} pixel signal of the first polarity and the N^{th} pixel signal of the second polarity based on a clock signal.

In addition, the second pixel sample unit receives a (N+1)^{th} pixel signal having the first polarity and a (N+1)^{th} pixel signal having the second polarity, and outputs one of the (N+1)^{th} pixel signal of the first polarity and the (N+1)^{th} pixel signal of the second polarity based on a clock signal. Wherein N is a positive integer and the first polarity is opposite to the second polarity. The pixel sample circuit receives and transmits one of the N^{th} pixel signals and the (N+1)^{th} pixel signals sequentially based on a clock signal.

According to an exemplary embodiment of the present invention, the first pixel sample unit includes a first storage unit, a second storage unit, and a first control switch set. Wherein, the first storage unit receives and stores the N^{th} pixel signal of the first polarity. Wherein, the second storage unit receives and stores the N^{th} pixel signal of the second polarity. The first control switch set is coupled to the first storage unit and the second storage unit to control the output of one of the N^{th} pixel signal of the first polarity and the N^{th} pixel signal of the second polarity.

According to an exemplary embodiment of the present invention, the second pixel sample unit includes a third storage unit, a fourth storage unit, and a second control switch set. Wherein, the third storage unit receives and stores the (N+1)^{th} pixel signal of the first polarity. The fourth storage unit receives and stores the (N+1)^{th} pixel signal of the second polarity. The second control switch set is coupled to the third storage unit and the fourth storage unit to control the output of one of the (N+1)^{th} pixel signal of the first polarity and the (N+1)^{th} pixel signal of the second polarity.

According to an exemplary embodiment of the present invention, each of the storage units includes a first switch and a storage device. Wherein, the first terminal of the first switch receives pixel signals; the first terminal of the storage device is coupled to the second terminal of the first switch; and the second terminal of the storage device is coupled to the ground. Wherein, the storage unit is a capacitor.

According to an exemplary embodiment of the present invention, when the clock signal is in the M^{th} period, the first storage unit and the second storage unit store the N^{th} pixel signal of the first polarity and the N^{th} pixel signal of the second polarity respectively. Wherein, both of the first switch in the first storage unit and in the second storage unit are on, and M is a positive integer.

According to an exemplary embodiment of the present invention, when the clock signal is in the (M+1)^{th} period, the first control switch set is coupled to the first storage unit; and when the clock signal is in the (M+2)^{th} period, the first control switch set is coupled to the second storage unit.

According to an exemplary embodiment of the present invention, the first control switch set includes a second switch and a third switch. The first terminal of the second switch is coupled to the second terminal of the first switch in the first storage unit, and the second terminal of the second switch is coupled to the second terminal of the first switch in the second storage unit. The first terminal of the third switch is coupled to the third terminal of the second switch, and the second terminal of the third switch outputs the N^{th} pixel signal.

Wherein, when the clock signal is in the (M+1)^{th} period, the first terminal and the third terminal of the second switch are on; when the clock signal is in the (M+2)^{th} period, the second terminal and the third terminal of the second switch are on; when the clock signal is in the (M+1)^{th} period and the (M+2)^{th} period, the third switch is on and the second control switch set is in open circuit status.

According to an exemplary embodiment of the present invention, when the clock signal is in the (M+2)^{th} period, the third storage unit and the fourth storage unit store the (N+1)^{th} pixel signal of the first polarity and the (N+1)^{th} pixel signal of the second polarity respectively. Both of the first switch of the third storage unit and of the fourth storage unit are on. When the clock signal is in the (M+3)^{th} period, the second control switch set is coupled to the third storage unit; and when the clock signal is in the (M+4)^{th} period, the second control switch set is coupled to the fourth storage unit.

According to an exemplary embodiment of the present invention, the second control switch set includes a second switch and a third switch. Wherein, the first terminal of the second switch is coupled to the second terminal of the first switch in the third storage unit; the second terminal of the second switch is coupled to the second terminal of the first switch in the fourth storage unit. The first terminal of the third switch is coupled to the third terminal of the second switch, and the second terminal of the third switch outputs the (N+1)^{th} pixel signal.

When the clock signal is in the (M+3)^{th} period, the first terminal and the third terminal of the fourth switch are on. When the clock signal is in the (M+4)^{th} period, the second terminal and the third terminal of the fourth switch are on. When the clock signal is in the (M+3)^{th} period and the (M+4)^{th} period, the fifth switch is on, and the first control switch set is in open circuit status.

In the present invention, because the line pair method is used for transmitting the scan line data of the frames to the LCD panel, and the LCD panel can be driven in column inversion, thus no extra memory or complex algorithm is needed, and the resolution of the displayed frames can be improved.

In order to make the aforementioned and other objects, features and advantages of the present invention comprehensible, a preferred embodiment accompanied with figures is described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram of the TV signal for an interlaced display.

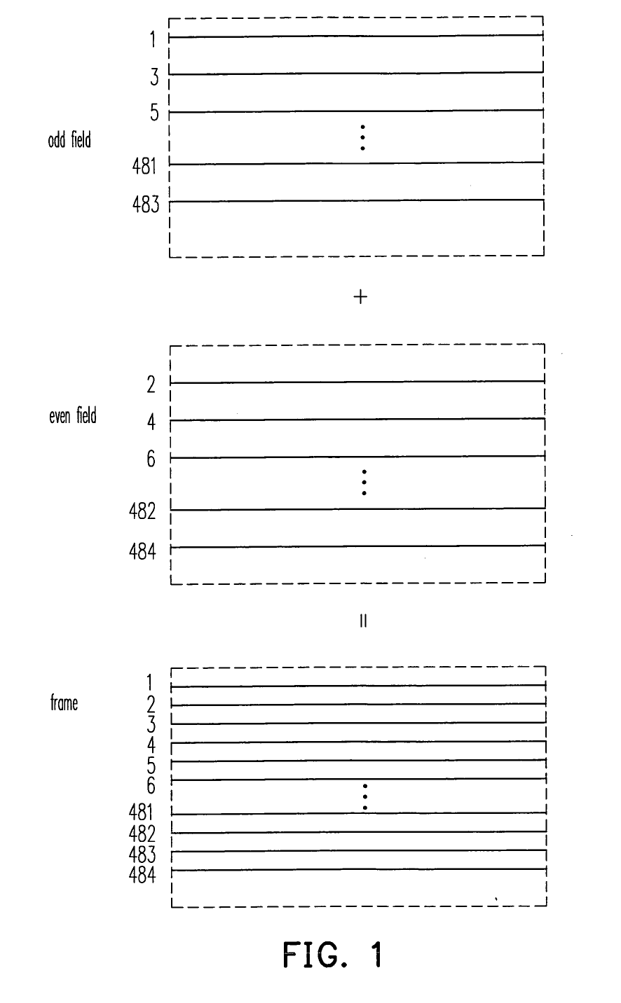

FIG. 2 is a diagram illustrating the operation of an interlaced display TV signal using an LCD.

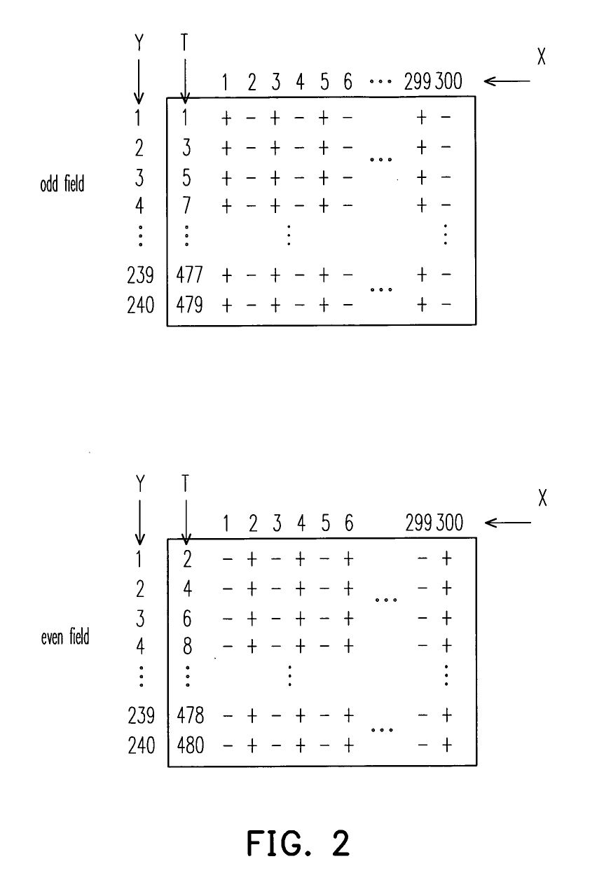

FIG. 3 is a circuit diagram of a conventional pixel sample circuit in an LCD panel.

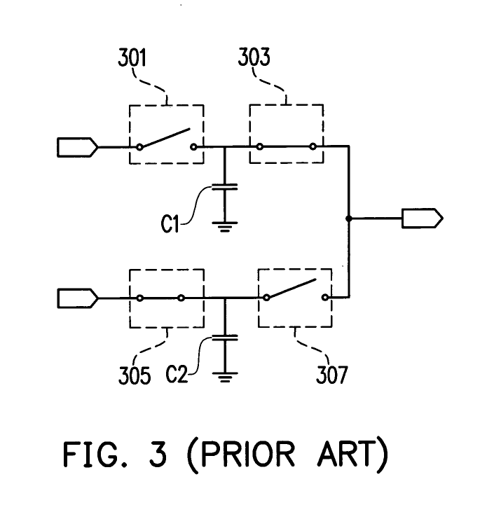

FIG. 4 is a circuit diagram illustrating a pixel sample circuit for an active matrix display according to an exemplary embodiment of the present invention.

FIG. 5 is a diagram illustrating the duty periods of each switch in a pixel sample circuit according to the exemplary embodiment of the present invention.

### DESCRIPTION OF EMBODIMENTS

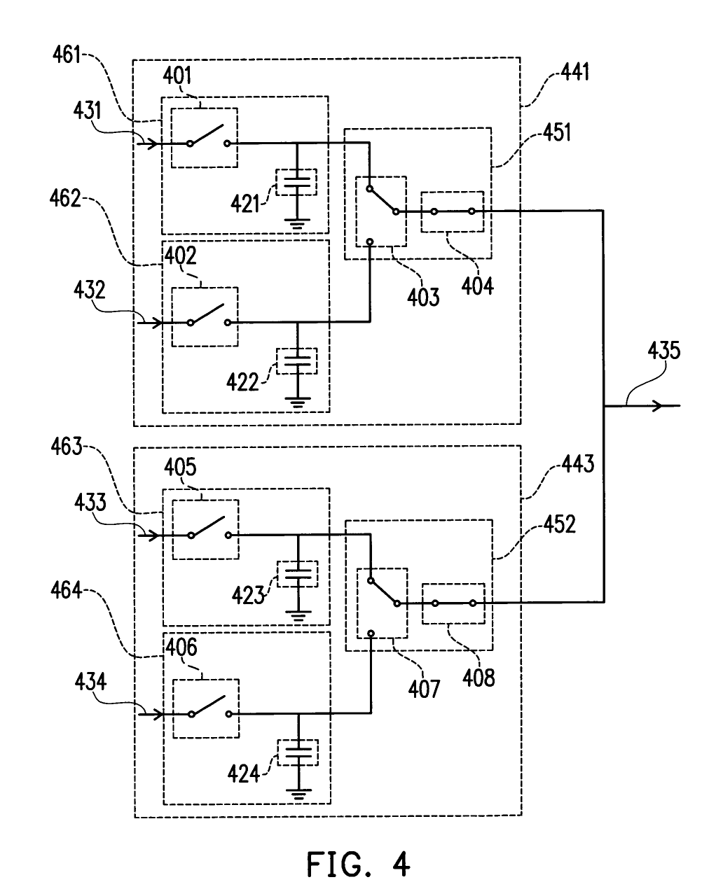

Referring to FIG. 4, it is a circuit diagram illustrating a pixel sample circuit for an active matrix display according to an exemplary embodiment of the present invention. As shown in FIG. 4, the aforementioned pixel sample circuit includes a first pixel sample unit 441 and a second pixel sample unit 443. Wherein, the first pixel sample unit 441 includes a first storage unit 461, a second storage unit 462, and a first control switch set 451. And the second pixel sample unit 443 includes a third storage unit 463, a fourth storage unit 464, and a second control switch set 452.

Wherein, each of the storage units further includes a switch and a storage device. For example, in the first pixel sample unit 441, the first storage unit 461 includes a first switch 401 and a first storage device 421, and the second storage unit 462 includes a second switch 402 and a second storage device 422. And the devices included in the second pixel sample unit 443 are similar to those included in the first pixel sample unit 441, so the details are not described here again.

In addition, each of the control switch sets further includes two control switches. Wherein, in the first control switch set 451, the first terminal of the third switch 403 is coupled to the second terminal of the first switch 401; and the second terminal of the third switch 403 is coupled to the second terminal of the second switch 402; the first terminal of the fourth switch 404 is coupled to the third terminal of the third switch 403; the second terminal of the fourth switch 404 is coupled to the output terminal 435 of the pixel sample circuit for outputting the pixel signals stored in the storage units.

In the second control switch set 452, the first terminal of the seventh switch 407 is coupled to the second terminal of the fifth switch 405; and the second terminal of the seventh switch 407 is coupled to the second terminal of the sixth switch 406; the first terminal of the eighth switch 408 is coupled to the third terminal of the seventh switch 407; and the second terminal of the eighth switch 408 is coupled to the output terminal 435 of the pixel sample circuit for outputting the said pixel signals stored in the storage units.

In the present embodiment, in the first storage unit 461 of the first pixel sample unit 441, the first terminal 431 of the first switch 401 receives the N^{th} pixel signal of the first polarity, and the first terminal 432 of the second switch 402 receives the N^{th} pixel signal of the second polarity. The first terminal of the first storage device 421 is coupled to the second terminal of the first switch 401; the first terminal of the second storage device 422 is coupled to the second terminal of the second switch 402; and the second terminal of each storage device is coupled to the ground.

In addition, in the second pixel sample unit 443 of the present embodiment, the coupling between devices is similar to that in the first pixel sample unit 441 so that the details are not described again. Wherein, the difference is that the first terminal 433 of the fifth switch 405 receives the (N+1)^{th} pixel signal of the first polarity and the first terminal 434 of the sixth switch 406 receives the (N+1)^{th} pixel signal of the second polarity.

Wherein, in the present embodiment, the storage devices 421 to 424 are to provide a storage function. For example, when the first switch 401 is on, the first storage unit 421 can store the pixel signal of the first polarity. And in the present embodiment, the storage units are replaced with capacitors, and any device which can provide storage function is acceptable in the present embodiment.

In the present embodiment, the first polarity is opposite to the second polarity. For example, the first polarity is positive and the second polarity is negative; or, the first polarity is negative and the second polarity is positive. If the bias applied to the data line are the same when the odd field and even field are being displayed alternately and continuously, but since the first polarity is opposite to the second polarity, thus the display panel can be driven inversely to avoid the problem of applying the electric field of single direction to the crystal liquid when different frames are displayed continuously.

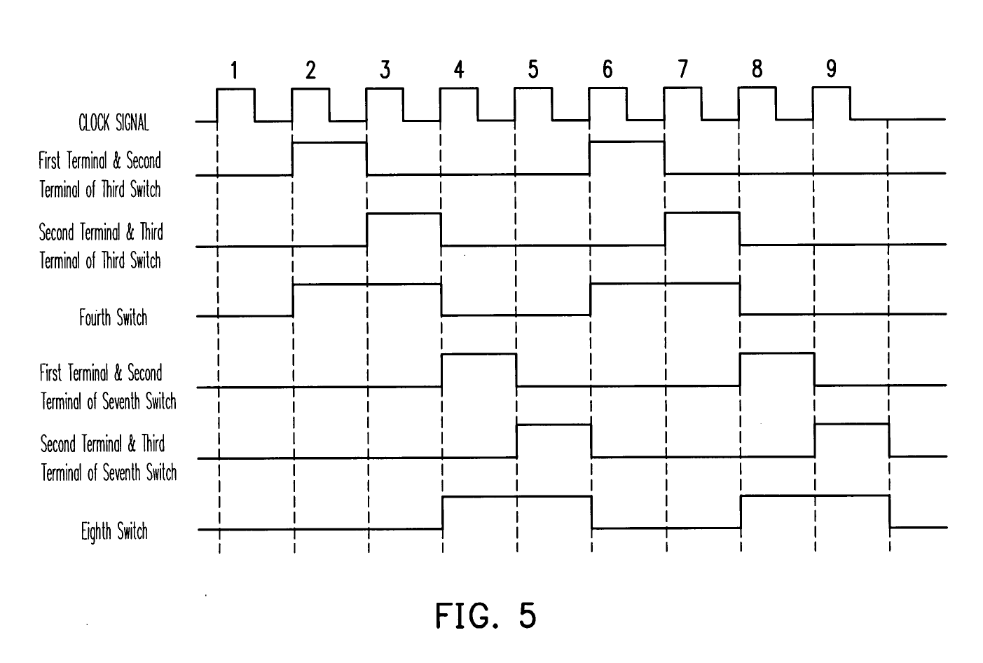

Referring to FIG. 5, which illustrates a diagram of the duty periods of each switch in a pixel sample circuit according to the exemplary embodiment of the present invention. For simplicity, when the switch is shown as at high level in the figure, it represents that the switch is on; and when the switch is shown as at low level, it represents that it is in open circuit status. The embodiment in FIG. 4 will be described as follows.

When the clock signal is in period 1, the first switch 401 and the second switch 402 are on, thus the first storage device 421 starts receiving and recording the N^{th} pixel signal of positive polarity; meanwhile, the second storage device 422 starts receiving and recording the N^{th} pixel signal of negative polarity.

When the clock signal is in period 2 and period 3, the fourth switch 404 is on and the eighth switch 408 is both off. When the clock signal is in period 3, the first terminal of the third switch 403 is coupled to the third terminal; and in period 4, the second terminal of the third switch 403 is coupled to the third terminal. Thus, only the N^{th} pixel signal of positive polarity is transmitted in period 2, and the N^{th} pixel signal of negative polarity is transmitted in period 3.

In addition, when the clock signal is in period 3, the fifth switch 405 and the sixth switch 406 are on, thus the third storage device 423 starts receiving and recording the (N+1)^{th} pixel signal of positive polarity; meanwhile, the fourth storage device 424 starts receiving and recording the (N+1)^{th} pixel signal of negative polarity.

When the clock signal is in period 2 and period 3, the fourth switch 404 is on; when the clock signal is in period 4 and period 5, the eighth switch 408 is on and the fourth switch 404 is off. When the clock signal is in period 4, the first terminal of the seventh switch 407 is coupled to the third terminal; in period 5, the second terminal of the seventh switch 407 is coupled to the third terminal. Thus, only the (N+1)^{th} pixel signal of positive polarity will be transmitted in period 4, and only the (N+1)^{th} pixel signal of negative polarity will be transmitted in period 5.

According to the above description, in the period before the fourth switch 404 and the eighth switch 408 are turned on, storage devices 421 to 424 will update the data stored within; then during the next two clock signal periods, two pixel signals of different polarities are transmitted respectively; accordingly, no extra memory for storing the data of the pixel signals is needed.

A typical active matrix display will receive the data line signal of the odd field and data line signal of the even field as described in conventional technology. In the embodiment described above, the pixel sample circuit may be the sample circuit of a data line in each display field. By using the pixel sample circuit exposed in the present invention, the frames of odd field and even field can be displayed alternately in the display panel.

In addition, if the number of scan line data is greater than the number of scan lines the display can display, for example, if an active matrix display having 240 scan lines is about to display an odd field (or even field) having 242 scan line data, two scan lines have to be discarded. Generally speaking, the method to delete the two scan lines is discarding the first and the last scan lines or other deletion methods; but as to the result, it does not affect the entire frame much.

In overview, in the present invention, because the line pair method is used for transmitting the scan line data of the frames to the LCD panel, and the LCD panel can be driven in column inversion, thus no extra memory or complex algorithm is needed, and the resolution of the displayed frames can be improved.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A pixel sample circuit for active matrix display, for providing a plurality of pixel signals required by a data line, wherein the pixel sample circuit comprising:
a first pixel sample unit used for receiving an N^{th} pixel signal having a first polarity and an N^{th} pixel signal having a second polarity, and for outputting one of the N^{th} pixel signal of the first polarity and the N^{th} pixel signal of the second polarity based on a clock signal; and
a second pixel sample unit used for receiving a (N+1)^{th} pixel signal having the first polarity and a (N+1)^{th} pixel signal having the second polarity, and for outputting one of the (N+1)^{th} pixel signal of the first polarity and the (N+1)^{th} pixel signal of the second polarity based on the clock signal;
wherein, N is a positive integer, the first polarity is opposite to the second polarity, and the pixel sample circuit receiving and transmitting one of the N^{th} pixel signal and the (N+1)^{th} pixel signal sequentially based on the clock signal.

2. The pixel sample circuit as claimed in claim 1, wherein the first pixel sample unit comprising:
a first storage unit used for receiving and storing the N^{th} pixel signal of the first polarity;
a second storage unit used for receiving and storing the N^{th} pixel signal of the second polarity; and
a first control switch set coupled to the first storage unit and the second storage unit, used for controlling the output of one of the N^{th} pixel signal of the first polarity and the N^{th} pixel signal of the second polarity.

3. The pixel sample circuit as claimed in claim 2, wherein the second pixel sample unit comprising:
a third storage unit used for receiving and storing the (N+1)^{th} pixel signal of the first polarity;
a fourth storage unit used for receiving and storing the (N+1)^{th} pixel signal of the second polarity; and
a second control switch set coupled to the third storage unit and the fourth storage unit, used for controlling the output of one of the (N+1)^{th} pixel signal of the first polarity and the (N+1)^{th} pixel signal of the second polarity.

4. The pixel sample circuit as claimed in claim 3, wherein each storage unit comprising:
a first switch, the first terminal thereof is used for receiving the pixel signals; and
a storage device, wherein the first terminal thereof is coupled to the second terminal of the first switch, and the second terminal thereof is coupled to the ground.

5. The pixel sample circuit as claimed in claim 4, wherein the storage device is a capacitor.

6. The pixel sample circuit as claimed in claim 4, wherein when the clock signal is in the M^{th} period, the first storage unit and the second storage unit storing the N^{th} pixel signal of the first polarity and the N^{th} pixel signal of the second polarity, respectively, wherein M is a positive integer.

7. The pixel sample circuit as claimed in claim 6, wherein the first switch of the first storage unit and the first switch of the second storage unit are on.

8. The pixel sample circuit as claimed in claim 7, wherein when the clock signal is in a (M+1)^{th} period, the first control switch set is coupled to the first storage unit.

9. The pixel sample circuit as claimed in claim 8, wherein when the clock signal is in a (M+2)^{th} period, the first control switch set is coupled to the second storage unit.

10. The pixel sample circuit as claimed in claim 9, wherein the first control switch set comprising:
a second switch having the first terminal thereof coupled to the second terminal of the first switch in the first storage unit, and the second terminal thereof coupled to the second terminal of the first switch in the second storage unit; and
a third switch having the first terminal thereof coupled to the third terminal of the second switch and the second terminal thereof outputting the N^{th} pixel signal.

11. The pixel sample circuit as claimed in claim 10, wherein when the clock signal is in the (M+1)^{th} period, the first terminal and the third terminal of the second switch are on.

12. The pixel sample circuit as claimed in claim 10, wherein when the clock signal is in the (M+2)^{th} period, the second terminal and the third terminal of the second switch are on.

13. The pixel sample circuit as claimed in claim 10, wherein when the clock signal is in the (M+1)^{th} period and the (M+2)^{th} period, the third switch is on.

14. The pixel sample circuit as claimed in claim 9, wherein when the clock signal is in the (M+1)^{th} period and the (M+2)^{th} period, the second control switch set is in open circuit status.

15. The pixel sample circuit as claimed in claim 9, wherein when the clock signal is in the (M+2)^{th} period, the third storage unit and the fourth storage unit store the (N+1)^{th} pixel signal of the first polarity and the (N+1)^{th} pixel signal of the second polarity respectively.

16. The pixel sample circuit as claimed in claim 15, wherein the first switch of the third storage unit and the first switch of the fourth storage unit are on.

17. The pixel sample circuit as claimed in claim 16, wherein when the clock signal is in a (M+3)^{th} period, the second control switch set is coupled to the third storage unit.

18. The pixel sample circuit as claimed in claim 17, wherein when the clock signal is in a (M+4)^{th} period, the second control switch set is coupled to the fourth storage unit.

19. The pixel sample circuit as claimed in claim 18, wherein the second control switch set comprising:
a second switch having the first terminal thereof coupled to the second terminal of the first switch in the third storage unit and the second terminal thereof coupled to the second terminal of the first switch in the fourth storage unit; and
a third switch having the first terminal thereof coupled to the third terminal of the second switch and the second terminal thereof outputting the (N+1)^{th} pixel signal.

20. The pixel sample circuit as claimed in claim 19, wherein when the clock signal is in the (M+3)^{th} period, the first terminal and the third terminal of the second switch are on.

21. The pixel sample circuit as claimed in claim 19, wherein when the clock signal is in the (M+4)^{th} period, the second terminal and the third terminal of the second switch are on.

22. The pixel sample circuit as claimed in claim 19, wherein when the clock signal is in the (M+3)^{th} period and the (M+4)^{th} period, the third switch is on.

23. The pixel sample circuit as claimed in claim 18, wherein when the clock signal is in the (M+3)^{th} period and the (M+4)^{th} period, the first control switch set is in open circuit status.

24. The pixel sample circuit as claimed in claim 1, wherein the first polarity is positive, and the second polarity is negative.
